(19) United States
(12) Patent Application Publication
(10) Pub. No.: US 2009/0316832 A1
(43) Pub. Date: Dec. 24, 2009

(54) Increasing Channel Capacity Without Needing to Reduce Signal to Noise Margin Due to Inter-Symbol Interference (ISI) by Using Three States +1, -1 and NO

(76) Inventor: Bob Tang, London (GB)

Correspondence Address: Bob Tang, Flat 1, Barkat House, 116-118 Finchley Road, Swiss Cottage, London, NW3 5HT, GB

(21) Appl. No.: 11/792,439

(22) PCT Filed: Dec. 8, 2005
(86) PCT No.: PCT/GB05/04721

§ 371 Date: Jun. 7, 2007

(30) Foreign Application Priority Data
Dec. 9, 2004 (GB) 0426965.0

(51) Int. Cl. H04L 27/32; H04L 27/04

(52) U.S. Cl. 375/311

(57) ABSTRACT

Basic idea is that in addition to sending +1 and −1 a third state is sent. This third state is a lack of any transmission whatsoever. Suggests sending frequency 0 for symbol 0, frequency 1 for symbol 1, frequency 2 for symbol 2, frequency 0 & frequency 1 for symbol 3 etc. Also suggests using 2 frequencies and phase modulating each. Frequency 1 has 2 possible phase states and frequency 2 has 2 possible phase states, therefore 4 bits can be coded. If send only frequency 2 with its two phase states, this enables us to send two more bits. If send neither frequency 1, nor frequency 2 this indicates 1 other bit state. Therefore 8 bits can be coded.

existing digital data transmission employ/consists mostly of binary modulation levels, eg two or n-ary distinct amplitude/voltage levels and/or two or n-ary distinct phases and/or two or n-ary distinct frequencies or their combinations thereof, due to signalling requirements over the carrier channel in presence of noise. Some do transmit using various combination n-ary levels, eg 4B3T, QAM . . . etc.

These could be supplemented by employing carrier (current or lightwave) on-off states to convey more states during a single interval. At present during a single interval only two states level could be conveyed in binary signalling (binary bit), eg using voltage level +1 & voltage level +0.5/voltage level +1 & voltage level −1/voltage level +1 & voltage level 0, OR phase shift 180 degrees & phase shift 0 . . . etc. Carrier on-off (ie detectable complete absence of carrier ie total absence of any voltages, amperes or phase . . . etc of the carrier current/lightwaves: detection of total absence of carrier, eg as in when the physical transmission link/physical carrier loop between the two ends are disconnected) here would now increase the states level conveyable during each interval.

For background materials on modulations, n-ary codings, optical transmission . . . etc see:

http://www.iec.org/online/tutorials/opt_trans/topic03.html

http://www.tpub.com/neets/tm/112-2.htm

Google Search term \grave{ } FIBER OPTIC TRANSMITTERS \grave{ }, \grave{ }
optical modulation \grave{ } , \grave{ } optical transmission \grave{ } , \grave{ }
optical detection \grave{ }

Google Group Search term ‘on off optical modulation’, ‘OOK modulation’

http://eserver.bell.ac.uk/mirrors/dc100www/dc 016.htm

http://members.aol.com/mirrors/dc100www/dc 016.htm

Google Search term ‘QAM’ file

http://www.s3.kth.se/radio/Publication/Pub2000/ZhuLei2000 2.ps

Google Search term ‘Frequency Division Multiplex’

Google Search term ‘Glossary of Telecommunication Terms Federal Standard 1037C

Google Search term ‘Amplitude Phase Keying with M-ary Alphabets’

Google search term ‘Carrier Synchronization and Detection of QASK Signal Sets’

Google Search term ‘Optical modulations’

Google Search term ‘n-ary modulations’ ‘n-ary code’

Google Search term ‘ternary modulations’, ‘ternary code’

Eg 56K modem line consists of 56,000 intervals per second, during which a binary bit of information could be conveyed. With the additional carrier/current on-off state (in addition to the carrier/current on state binary two level states conveyable), more states could be conveyed in each bit interval. This would increase the modem line bandwidth far beyond 56K/sec. The off modulation state denoting eg symbol 2 ie complete switching off of any transmission corresponding to a bit interval unit, and the pre-existing binary modulation of eg −1V for symbol 0 and +1V for symbol 1, are completely orthogonal channel noises wise ie there is no possibility of an ‘on’ modulation of either +/−1V mis-detected as ‘off’ modulation where there is no transmissions whatsoever for the particular bit interval: even if the +/−1V being affected by channel noises to be mis-detected at receiver to be 0V, the receiver will know this is not an ‘off’ modulation, since receiver will recognise an ‘off’ complete non-transmission from complete absence of signal during a bit interval unit which is also further accompanied by total absence of amplitude/phase/frequency detection during this time. Here modem transmitter & receiver software/firmware/hardware needs be adapted to detect the presence/absence of carrier/current during each bit interval.

Similar to above on-off signal transmission (ie completely switching on off of the modulated carrier or pure baseband transmissions, not transmitting anything at all when off) together with pre-existing amplitude modulation/phase modulation/frequency modulation/or various combinations to increase the symbol constellation per bit (increased by 1 in n-ary, or double in 2en-ary), existing frequency shift keying (eg transmitting one frequency for binary 1, and another different frequency for 0) method could be readily adapted to use n-ary level symbols eg transmitting frequency F(0) for symbol 0, transmitting frequency F(1) for symbol 1, transmitting frequency F(2) for symbol 2 . . . transmitting frequency F(n) for symbol n. Further this n-ary frequency shift keying method (choosing only one of the n frequencies to transmit at any one time) could further be adapted so that any combinations of frequencies, ie constellation of frequencies, may be transmitted at any one time over the media, thus in effect expanding the maximum number of symbols possible with n number of frequencies beyond n to effectively 2en (2 to the power n, ie multiplying 2 by itself n number of times). This would require receiver to be adapted to detect n number of frequencies at any one time.

Eg transmitting frequency F(0) for symbol 0, transmitting frequency F(1) for symbol 1, transmitting frequency F(2) for symbol 2, transmitting frequencies F(0) & F(1).for symbol 3, transmitting frequencies F(0) & F(2) for symbol 4, transmitting F(1) & F(2) for symbol 5, transmitting F(0) & F(1) & F(2) for symbol 6, not transmitting any of F(0) & F(1) & F(2) for symbol 7. Where the frequencies F(n) each occupies separate distinct different region of the channel's frequency spectrum (as in frequency division multiplex transmission method), this would ensure channel noise affects on each frequencies are orthogonal or would be close to orthogonal (ie assuming media noise affecting a particular frequency would not identically affect another frequency or not by much at the same time)

Its not possible to adapt above orthogonal n-ary levels symbols (and/or further 2en-ary frequencies constellation symbols) method to amplitude modulations alone, which uses a single modulated carrier for transmissions, since the modulated carrier could only be at a certain single voltage level or phase instantaneously at any one time. This would then be similar to existing n-ary multi voltage levels representations of n-ary symbols per bit eg in ternary encoding 0V for 0 symbol/+1V for 1 symbol/−1V for 2 symbol, which would inherently reduces the channel's signal to noise margin eg from 2V separations (+1V−(−1V)=2V separation for binary levels symbol) to just 1V (+1V−0V=1V). Likewise it's not possible to adapt 2en-ary constellation symbols method to phase modulations. Doing so would necessarily entail reduction in the inter-levels (amplitude and/or phase) noise margin or inter-symbol interference (ISI), effectively giving the same noise ratio between levels/symbols as in present methods of multi level amplitude modulations or present methods of multi level phase shift keying, or their combinations thereof such as eg QAM quadrature amplitude modulation where 2 levels amplitude and 2 phase changes are used in the single modulated signal-transmitted.

Note however if the two amplitude levels and two phase changes are modulated onto two separate independent frequencies ie the two frequency signals (one amplitude modulated and the other phase modulated) are transmitted at the same time or these two different frequency signals are combined into a single signal before being transmitted (in which case receiver may process and separate the single combined different frequencies signal into their original two frequencies for amplitude and phase processing respectively), 3e2-ary ie 9-ary levels/symbols per bit modulation could be attained instead of the 4-ary QAM modulation: since there are 4 possible combinations of complete on-off permutations of the any of the two different frequency signals which receiver could be adapted to detect individually giving eg both frequency on for combinations of two amplitudes and two phase representing symbols 0-3, one frequency on the other off for the two amplitudes representing symbols 4 & 5, the other frequency on and one frequency off for the two phase representing symbols 6 & 7, both frequencies off representing symbol 8. The levels in each of the two frequencies are assumed to be orthogonal or close to being orthogonal to each other channel noise impairment wise, hence this increase from 4-ary to 9-ary modulation is achieved without additional signal noise penalty over present QAM method, only cost being utilising 2 different frequencies and simple adaptations of transmitter & receiver software/firmware/hardware.

In general, where the combinations of transmission characteristics employed for modulations are orthogonal (eg amplitudes, phase, frequencies, switching on off of transmissions: they are all orthogonal to each other & generally channel noises which affect one usually does not have much the same effects on any of the others), 2en-ary constellation symbols method could be implemented. This would tremendously increase the information capacity of the transmission channel, eg if using complete switching on-off of transmission to enable ternary symbol constellation per bit (eg complete non-transmission for symbol 2/amplitude +1V or frequency F(0) for symbol 0/amplitude −1V or frequency, F(1) for symbol 1), 56K modem could now theoretically transfer 3e56K/2e56K times more information in a second in terms of largest numeric number representable in 56,000 ternary bits vs 56,000 binary bits, or if further adapt above ternary to using 2e2 symbols constellation method described (complete switching on-off of transmissions for symbol 3/frequency F(0) for symbol 0/frequency F(1) for symbol 1/both frequencies F(0) & F(1) for symbol 2, on-off/F(0)/F(1) each being orthogonal channel noise interference wise), the 2e2=4 symbols constellation here being eg complete off for symbol 3/both F(1) & F(2) for symbol 2/F(1) only for symbol 1/F(0) only for symbol 0, 56K modem could now theoretically transfer 56,000*56,000 times more information per second in terms of largest numeric number representable (ie 4e56K/2e56K), or approx 50% more information capacity in terms of number of possible symbols per bit transferable using (2+1)ary scheme over binary, or approx 100% more ie double information capacity in terms of number symbols per bit transferable in (2e2)ary scheme (2 to the power 2) over binary.

It is noted that the telephone line into analog modem could be removed for a short period of time, then reconnect back into the modem, without the modem data communications being terminated. In off-off complete non-transmission modulation together with pre-existing modem binary modulation (or even other pre-existing n-ary modulations) to implement (n+1)-ary symbols per bit encoding (or even further 2en-ary encoding), the line coding and/or channel coding schemes should be devised to ensure bit stream/clock synchronisations is not lost due to a long period of continuous off complete non-transmission (similar to pre-existing various line coding/channel coding schemes which preserves bit stream/clock synchronisations). The modem software/firmware and/or hardware needs be adapted to detect off complete non-transmission, ie no signal at all, which could also further be indicated by complete absence of accompanying amplitude and phase and frequency.

Existing state of art techniques already exist to convert binary date into ternary/quadrary/n-ary/2en-ary for transmission modulations eg QAM . . . etc, eg converting existing common ubiquitous deployed binary coding bits 3 bits at a time into 2 ternary coding bits for transmissions . . . etc.

Synchronous and/or asynchronous timing could be derived from the ternary data streams adapted from existing similar methods for binary data stream/clock synchronisations.

Existing commonly deployed optical signal modulations includes amplitude keying (altering intensity of light beam or complete switching on off of light beam), phase shift keying, frequency shift keying, OOK on-off keying (complete switching on-off of transmissions light source or shuttering), or n-ary implementations of above combinations. Thus as can be seen on-off OOK on-off keying modulation is well established, & could be combined with any of the other amplitude/phase/frequency modulations or their multi level n-ary symbol constellation per individual bit implementations thereof, to tremendously increase the information transfer capacity, or further could be even be combined to provide 2en symbols constellation per individual bit modulations (preferably where their modulations characteristics/parameters combinations transmission characteristics are orthogonal, or close to orthogonal channel noise wise, eg complete on-off together with light intensity, and/or phase, and/or frequencies, and/or their combinations such as QAM)

To implement this invention, existing OOK (complete switching on off of light source) could be readily combined with existing n-ary phase or frequency shift modulations with complete switching off of light source representing symbol n+1, when light source is ‘on’ n number of symbols are represented giving n+1-ary levels/symbols per bit. When combining existing OOK (complete switching on off of light source) together with binary Light Intensity modulation it may possibly not even matter if choice of the voltage level of symbol 0 Light Intensity modulation is 0 instead of the preferred voltage level one-half of that of symbol 1, ie same as when complete switching ‘off’ of light source: since complete switching ‘off’ of light source would also be in addition to 0 voltage accompanied by total absence of phase and frequency detections. Complete absence of phase could eg be detected by combining local receiver generated oscillator signal with incoming signal/separated component of incoming combined signals to determine absence of incoming signal from observation of the multiplied combined incoming signal/separated component signals and local receiver generated oscillator signal/s being identical in amplitude and phase and frequency.

When implementing this invention by combining OOK with n-ary frequency shifts, if each of n levels or symbols of the frequency modulation are carried/indicated by m number of separate distinct independent frequency regions on-off transmitted independently at the same time or combined before being transmitted, and each frequencies can convey s levels or symbols (here n=m*s), then the number of levels/symbols achievable per bit here would be: s to the power m.

This invention does not need to introduce any reduced inter-level or inter-symbol signal to noise ratio, and does not need to introduce any higher signalling power requirements.

Various existing techniques applied to binary carrier to detect/prevent faulty continuous same state transmissions, and/or to ensure bit stream/clock synchronisations eg existing encoding schemes bit synchronisations/error corrections considerations adapted for the purpose (eg to prevent too long a period of continuous ‘off’)/Phase Lock Loop/Digital Phase Lock Loop . . . etc could similarly be deployed to detect prevent faulty continuous carrier off-state/current off-state (ie absence of carrier) eg due to complete line loss.

Existing transmission modulations, telecommunications infrastructure are almost ubiquitous binary. For incremental deployments, interface software/firmware/hardware needs to convert various binary line/channel coding into n-ary eg ternary line/channel codings: one simple way is to convert 3 binary bits into 2 ternary bits (3 levels/symbols per bit) or even just one 2e3-ary ie 8-ary bit. And Vice Versa, at the transmission hands-off points. Intercontinental submarine cables/satellites/backbones links would be ideal for initial deployments.

Those skilled in the arts may make various modifications to the principle described yet they will fall within the scope of the invention.

1. Methods of modulations &/or line coding/encoding, where the whole complete transmission carrier, such as eg current/lightwaves/electromagnetic waves utilised in pre-existing amplitude modulation/frequency modulation/phase modulation &/or various combinations thereof, is additionally further made switchable on-off (when completely switching carrier off, is detectable at receiver by complete absence of carrier eg total absence of any voltage amplitude, any frequency, any phase), thus increasing the states level conveyable during each bit's assigned interval time period compared to pre-existing amplitude modulation/frequency modulation/phase modulation &/or various combinations thereof.

2. Methods of modulations &/or line coding/encoding, where the whole complete transmission carrier, such as eg current/lightwaves/electromagnetic waves utilised in pre-existing amplitude modulation/frequency modulation/phase modulation &/or various combinations thereof, is additionally further made switchable on-off (when completely switching carrier off, is detectable at receiver by complete absence of carrier eg total absence of any voltage amplitude, any frequency, any phase), thus increasing the states level conveyable during each bit's assigned interval time period to n-ary +1 &/or 2e(n+1)-ary &/or (base)e(n+1)-ary compared to pre-existing amplitude modulation/frequency modulation/phase modulation &/or various combinations thereof.

3. Methods of modulations &/or line coding/encoding, where the whole complete transmission carrier, such as eg current/lightwaves/electromagnetic waves utilised in pre-existing amplitude modulation/frequency modulation/phase modulation &/or various combinations thereof, is additionally further made switchable on-off (when completely switching carrier off, is detectable at receiver by complete absence of carrier eg total absence of any voltage amplitude, any frequency, any phase), thus increasing the states level conveyable during each bit's assigned interval time period compared to pre-existing amplitude modulation/frequency modulation/phase modulation &/or various combinations thereof, and the transmission channel capacity is thus increased, without needing to reduce Signal to Noise margin due to Inter-Symbol Interference (ISI) nor needing to introduce higher signalling power.

4. Methods as in accordance any of claims 1-3 above, where the modem transmitter &/or receiver software/firmware/hardware are adapted to detect the presence of carrier, &/or complete absence of carrier ie no signal at all which could be indicated by complete absence of accompanying voltage amplitude and phase and frequency components.

5. Methods as in accordance with any of the claims 1-4, where any combinations/subsets of frequencies (ie constellation of frequencies) may be transmitted &/or combined to be transmitted at any one time over the channel, and the Methods disclosed in any of the claims 1-4 above is additionally applied to each of the individual frequencies &/or the single combined combination/subset frequencies, thus expanding the maximum number of symbols possible per transmission bit/constellation per bit.

6. Methods as in accordance with any of the claims 1-5 above, where the line coding/encoding scheme further incorporates bit stream &/or clock synchronisation.

7. Methods as in accordance with any of the claims 1-6 above, where the whole complete transmission carrier, such as eg current/lightwaves/electromagnetic waves utilised in pre-existing amplitude modulation/frequency modulation/phase modulation &/or various combinations thereof, could additionally further be made switchable on-off (when completely switching carrier off, detectable at receiver by complete absence of carrier eg total absence of any voltage amplitude, any frequency, any phase) similar to pre-existing optical OOK (on-off keying) complete switching on-off of light source techniques.
